(19) United States
(12) Patent Application Publication
(10) Pub. No.: US 2026/0141390 A1
(43) Pub. Date: May 21, 2026

(54) FRAUD DETECTION BASED ON COLLABORATIVE FILTERING

(71) Applicant: MASTERCARD INTERNATIONAL INCORPORATED, PURCHASE, NY (US)

(72) Inventors: Rohit Jain, Jalaun (IN); Anubha Pandey, Bikaner (IN); Sachin ., Alwar (IN)

(21) Appl. No.: 18/951,636

(22) Filed: Nov. 18, 2024

(51) Int. Cl. G06Q 20/40

(52) U.S. Cl. CPC G06Q 20/4016

(57) ABSTRACT

A method for facilitating fraud detection based on collaborative filtering is provided. The method includes segregation of payment modes into payment mode clusters and merchants into merchant clusters based on first historical transaction data associated therewith. Further, a collaborative filtering (CF) matrix is generated based on the payment mode clusters, merchant clusters, and second historical transaction data. Additionally, CF features are created for each payment mode cluster-merchant cluster pair based on the CF matrix and second historical transaction data. A risk score machine-learning model (ML) is trained based on created CF features and non-CF features. The risk score ML model is operable to classify a transaction request to one of a fraudulent transaction request and legitimate transaction request based on the training.

### FIELD

Various embodiments of the present disclosure relate generally to fraud detection. More particularly, various embodiments of the present disclosure relate to fraud prediction based on collaborative filtering.

### BACKGROUND

The rapid technological advancements in the field of financial transactions have led to the introduction of electronic transactions that allow users to electronically transfer funds in real-time without the need for physical cash. Additionally, the rise of digital wallets, online banking, and mobile payment applications have resulted in a surge in the volume of electronic transactions. In recent years, an increase in fraudulent activities associated with such transactions has occurred. Fraudulent activities in electronic payment transactions occur in many forms, including identity theft, account takeover, card-not-present fraud, and the like. The fraudulent activities result in substantial financial losses and erode consumer trust in electronic payment systems.

In light of the foregoing, there is a need for a technical solution that solves the abovementioned problems.

### SUMMARY

Methods and systems for facilitating fraud detection based on collaborative filtering are provided substantially as shown in and described in connection with, at least one of the figures, as set forth more completely in the claims.

In an embodiment of the present disclosure, a method for training a risk score machine-learning model is provided. The method includes segregating, by a server, a plurality of payment modes into a plurality of payment mode clusters and a plurality of merchants into a plurality of merchant clusters, based on first historical transaction data. The method further includes generating a collaborative filtering (CF) matrix based on the plurality of payment mode clusters, the plurality of merchant clusters, and second historical transaction data, by the server. Each cell of the CF matrix is associated with a corresponding payment mode cluster of the plurality of payment mode clusters and a corresponding merchant cluster of the plurality of merchant clusters. Furthermore, the method includes determining, by the server, a CF score for each cell of the CF matrix based on the CF matrix and creating a plurality of CF feature values for each cell of the CF matrix based on a corresponding CF score and the second historical transaction data. Additionally, the method includes, training, by the server, a risk score machine-learning (ML) model based on the plurality of CF feature values and a plurality of non-CF feature values, associated with each cell of the CF matrix. The risk score ML model is operable to classify a transaction request as one of a fraudulent transaction request or a legitimate transaction request based on the training.

In another embodiment, a method for facilitating fraud detection based on collaborative filtering is provided. The method includes receiving, by a server, a transaction request associated with a target payment mode and a target merchant. Further, the method includes identifying, by the server, a target payment mode cluster of a plurality of payment mode clusters that is associated with the target payment mode and a target merchant cluster of a plurality of merchant clusters that is associated with the target merchant. The method further includes retrieving, by the server from a memory, a plurality of collaborative filtering (CF) feature values associated with the target payment mode cluster and the target merchant cluster. The method further includes inputting, by the server, the retrieved plurality of CF feature values and a plurality of non-CF feature values associated with at least one of the target payment mode and the target merchant, to a trained risk-score machine-learning (ML) model. The method further comprises, obtaining, by the server, a risk score as an output of the trained risk score ML model, where the transaction request is classified as one of a fraudulent transaction request or a legitimate transaction request based on the risk score.

In yet another embodiment of the present disclosure, a system for facilitating fraud detection based on collaborative filtering is provided. The system includes a server comprising a memory configured to store a risk score machine learning (ML) model and processing circuitry coupled to the memory. The processing circuitry is configured to segregate a plurality of payment modes into a plurality of payment mode clusters and a plurality of merchants into a plurality of merchant clusters, based on first historical transaction data. Further, the processing circuitry is configured to generate a collaborative filtering (CF) matrix based on the plurality of payment mode clusters, the plurality of merchant clusters, and second historical transaction data. Each cell of the CF matrix is associated with a corresponding payment mode cluster of the plurality of payment mode clusters and a corresponding merchant cluster of the plurality of merchant clusters. Furthermore, the processing circuitry is configured to determine a CF score for each cell of the CF matrix and create a plurality of CF feature values for each cell of the CF matrix based on the corresponding CF score and the second historical transaction data. Additionally, the processing circuitry is configured to train the risk score ML model based on the created plurality of CF feature values and a plurality of non-CF feature values, where the risk score ML model is operable to classify a transaction request as one of a fraudulent transaction request or a legitimate transaction request based on the training.

In some embodiments, the segregation of the plurality of payment modes into the plurality of payment mode clusters and the plurality of merchants into the plurality of merchant clusters, includes creating, by the server, a plurality of payment mode clustering features for each payment mode of the plurality of the payment modes and a plurality of merchant clustering features for each merchant of the plurality of the merchants based on the first historical transaction data. Furthermore, the method includes executing, by the server, a trained clustering ML model, based on the created plurality of payment mode clustering features and the created plurality of merchant clustering features.

In some embodiments, the method further includes training, by the server, a clustering ML model to obtain the trained clustering ML model.

In some embodiments, the method further includes storing, by the server, the plurality of CF feature values associated with each cell of the CF matrix in a memory.

In some embodiments, each cell of the CF matrix is indicative of a number of transactions between the corresponding payment mode cluster of the plurality of payment mode clusters and the corresponding merchant cluster of the plurality of merchant clusters.

In some embodiments, the plurality of payment modes and the plurality of merchants are associated with a geographical location.

In some embodiments, the first historical transaction data and the second historical transaction data are mutually exclusive.

In some embodiments, the first historical transaction data and the second historical transaction data are mutually inclusive.

In some embodiments, the first historical transaction data and the second historical transaction data are identical.

In some embodiments, each merchant cluster of the plurality of merchant clusters is associated with a merchant transaction pattern, and where each payment mode cluster of the plurality of payment mode clusters is associated with a payment mode transaction pattern.

In some embodiments, each payment mode of the plurality of payment modes corresponds to one of a payment card, a digital wallet, or a virtual payment address.

In some embodiments, the method further includes, determining, by the server, the transaction request as the fraudulent transaction request based on the risk score. Furthermore, the method includes, transmitting, by the server, an alert message to an issuer associated with the target payment mode, where the alert message indicates the issuer to reject the transaction request.

In some embodiments, the method further includes, receiving, by the server, an indication that the transaction request is one of the fraudulent transaction request or the legitimate transaction request after the classification of the transaction request as one of the fraudulent transaction request or the legitimate transaction request. Further, the method includes, generating, by the server, a plurality of weights associated with the trained risk score ML model based on the indication. Additionally, the method further includes, retraining, by the server, the trained risk score ML model based on the generated plurality of weights.

In some embodiments, the transaction request is associated with one of a card present transaction, a card not present transaction, an electronic wallet (e-wallet) payment transaction, or a mobile payment transaction.

In some embodiments, the target payment mode cluster is identified based on a similarity in a payment mode transaction pattern of the target payment mode and a payment mode transaction pattern of the target payment mode cluster.

In some embodiments, the target merchant cluster is identified based on a similarity in a merchant transaction pattern of the target merchant and a merchant transaction pattern of the target merchant cluster.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a system environment for facilitating fraud detection based on collaborative filtering, in accordance with an exemplary embodiment of the present disclosure;

FIG. 2 is a block diagram that illustrates a payment network server of the system environment of FIG. 1, in accordance with an exemplary embodiment of the present disclosure;

FIG. 3A represents a block diagram that illustrates segregation of a plurality of payment modes of the system environment into a plurality of payment mode clusters and a plurality of merchants of the system environment into a plurality of merchant clusters, in accordance with an exemplary embodiment of the present disclosure;

FIG. 3B illustrates a collaborative filtering (CF) matrix generated based on the plurality of payment mode clusters and the plurality of merchant clusters, in accordance with an exemplary embodiment of the present disclosure;

FIG. 3C illustrates an engineered CF feature table stored in a memory of the payment network server, in accordance with an exemplary embodiment of the present disclosure;

FIG. 3D is a block diagram that illustrates training of a risk score machine-learning (ML) model by the payment network server, in accordance with an exemplary embodiment of the present disclosure;

FIG. 4 is a block diagram that illustrates implementation of a trained risk score ML model by the payment network server, in accordance with an exemplary embodiment of the present disclosure;

FIG. 5 represents a high-level flowchart that illustrates a method (e.g., a process) for training a risk score ML model by the payment network server, in accordance with an exemplary embodiment of the present disclosure;

FIG. 6 represents a high-level flowchart that illustrates a method (e.g., a process) for facilitating fraud detection based on collaborative filtering by the payment network server, in accordance with an exemplary embodiment of the present disclosure;

FIGS. 7A-7C, collectively, represents a flowchart that illustrates a method (e.g., a process) for facilitating fraud detection based on collaborative filtering by the payment network server, in accordance with an exemplary embodiment of the present disclosure; and

FIG. 8 is a block diagram that illustrates a system architecture of a computer system of the system environment of FIG. 1, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

As users increasingly rely on electronic transactions, there exists a need for fraud detection in electronic transactions.

Conventional techniques for fraud detection utilize historical transaction data corresponding to a merchant-payment mode pair associated with a transaction request to detect whether the transaction request is a fraudulent transaction request or a legitimate transaction request. When a transaction is initiated between a merchant-payment mode pair for the first time, the conventional technique fails to detect fraud or results in a false positive fraud detection. Alternatively, historical transaction data of a payment mode associated with similar merchants may be utilized to detect fraud. However, computational power and time associated with the fraud detection using the above-described technique are high. Thus, there is a need for accurate and efficient fraud detection.

Various embodiments of the present disclosure disclose a method and a system that facilitates fraud detection based on collaborative filtering (CF). The method includes segregating payment modes into payment mode clusters such that each payment mode cluster includes similar payment modes. Similarly, merchants are segregated into merchant clusters such that each merchant cluster includes similar merchants. The segregation is performed based on historical transaction data associated with the payment modes and the merchants. Additionally, a CF matrix is generated based on the payment mode clusters and the merchant clusters. Further, CF features are created for each payment mode-merchant cluster pair of the CF matrix. A risk score machine-learning (ML) model is trained based on the created CF features and non-CF features. The risk score ML model is operable to classify a transaction request as one of a fraudulent transaction and a legitimate transaction based on the training.

In additional embodiments, a transaction request is received during implementation of the trained risk score ML model. The transaction request is associated with a target merchant and a target payment mode. A target merchant cluster associated with the target merchant and a target payment mode cluster associated with the target payment mode may be identified. Further, CF feature values associated with the target payment mode cluster and the target merchant cluster are retrieved from a memory. Additionally, the retrieved CF feature values and non-CF feature values associated with at least one of the target merchant and the target payment mode are provided as input to the trained risk score ML model. Further, a risk score associated with the transaction request is obtained as an output of the trained risk score ML model. The transaction request may be classified as one of the fraudulent transaction request or the legitimate transaction request based on the risk score.

The fraud detection technique described in one or more embodiments of the present disclosure provides higher accuracy in fraud detection as compared with conventional fraud detection techniques. The higher accuracy occurs due to utilization of historical transactions associated with similar merchants and similar payment modes. Additionally, time and computational power required for training the risk score ML model is significantly lower in comparison to the conventional techniques. The present method and system perform accurate fraud detection for a transaction that is initiated between a merchant-payment mode pair for the first time as historical transactions associated with a corresponding merchant cluster and a payment mode cluster are considered for the fraud prediction. Thus, the present disclosure provides methods and systems for accurate and efficient fraud detection in payment transactions.

### Terms Description (In Addition to Plain and Dictionary Meaning)

Payment mode is a medium that is utilized to initiate payment transactions. Examples of the payment mode include a payment card, a digital wallet, a virtual payment address, or the like.

Merchant refers to an individual or a business entity that offers various products and/or services in exchange for payments. The merchant may establish a merchant account with a financial institution, such as a bank to accept the payments from several users.

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to an acquirer server, a payment network server, or an issuer server.

Issuer is a financial institution, such as a bank, where accounts of several users are established and maintained. The issuer ensures payment for approved transactions in accordance with various payment network regulations and local legislation.

Payment networks act as intermediate entities between acquirer banks and issuer banks to authenticate and fund transactions.

Transaction request is associated with a transaction initiated between a payment mode and a merchant.

First historical transaction data may include details of a plurality of historical transactions associated with a plurality of payment modes and a plurality of merchants over a first time period.

Second historical transaction data may include details of a plurality of historical transactions associated with a plurality of payment modes and a plurality of merchants over a second time period.

Payment mode cluster refers to a set of payment modes having similar features. Similar features may correspond to historical transaction pattern associated with the payment modes.

Merchant cluster refers to a set of merchants having similar features. Similar features may correspond to historical transaction pattern associated with the merchants.

Machine-learning (ML) model refers to a model that is realized by one or more ML algorithms that learn patterns from training data to one of classify new data, predict a result based on the new data, or make decisions based on the new data. Examples of a machine-learning algorithm may include but are not limited to, K-means clustering, hierarchical clustering, decision trees, neural networks, linear regression, Random Forest, support vector machines, or the like. Further, the ML model may be trained accordingly to perform a variety of tasks such as clustering of entities based on the similarity features, prediction tasks, or the like.

Collaborative filtering (CF) matrix is a matrix that is formed based on a plurality of payment mode clusters and a plurality of merchant clusters where each cell of the CF matrix indicates interactions between a corresponding payment mode cluster of the plurality of payment mode clusters and a corresponding merchant cluster of the plurality of merchant clusters.

CF Score represents a likelihood of a new transaction between a payment mode cluster and a merchant cluster in the CF matrix.

Risk score represents a level of risk associated with a transaction request associated with a target payment mode and a target merchant.

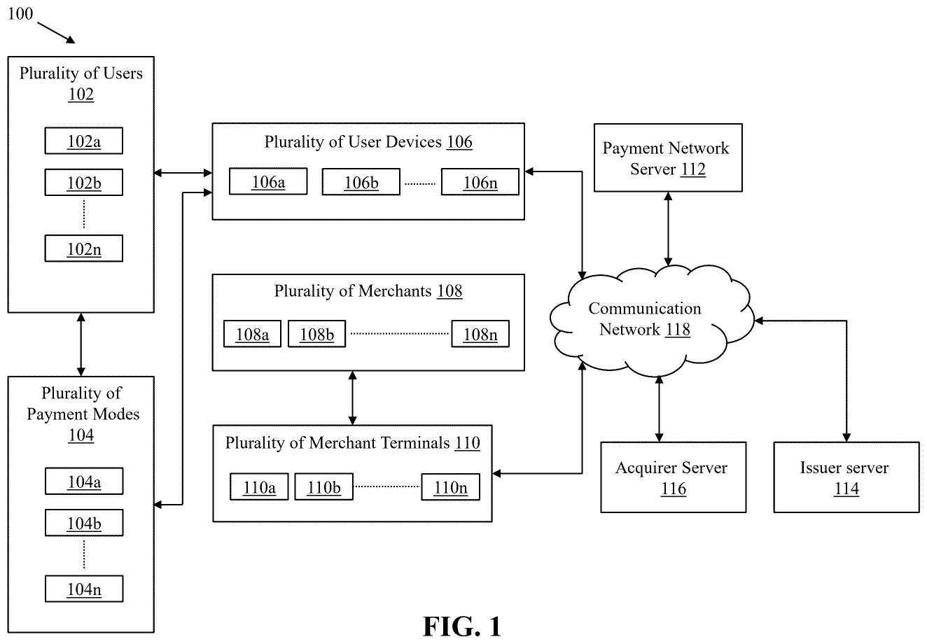

FIG. 1 is a block diagram that illustrates a system environment 100 for facilitating fraud detection based on collaborative filtering, in accordance with an exemplary embodiment of the present disclosure. The system environment 100 may include a plurality of users 102, a plurality of payment modes 104, a plurality of user devices 106, a plurality of merchants 108, a plurality of merchant terminals 110, a payment network server 112, an issuer server 114, an acquirer server 116, and a communication network 118. The plurality of user devices 106, the plurality of merchant terminals 110, the payment network server 112, the issuer server 114, and the acquirer server 116 may communicate with each other by way of the communication network 118 or through a separate communication network established therebetween.

The plurality of users 102 may include a first user 102a, a second user 102b, until an nth user 102n. Each user of the plurality of users 102 may be associated with one or more payment accounts maintained at a financial institution such as an issuer. Examples of the payment account may include a savings account, a current account, a debit account, a credit account, a digital wallet account, or the like. Further, the plurality of payment modes 104 may include a first payment mode 104a, a second payment mode 104b, until an nth payment mode 104n.

The plurality of users 102 may be associated with the plurality of payment modes 104. Each user may utilize a corresponding payment mode to perform one or more payment transactions associated with a corresponding payment account. The plurality of payment modes 104 are issued to the plurality of users 102 by the financial institution. In an example, the first payment mode 104a may be utilized by the first user 102a to perform a payment transaction. The first payment mode 104a is a medium that facilitates the first user 102a to access the corresponding payment account maintained at the financial institution.

A payment transaction refers to transfer of funds from one payment account to another payment account. A payment mode may be utilized to perform the payment transaction. Examples of the payment mode may include but are not limited to, a payment card, a digital wallet, a virtual payment address (VPA), or the like. A payment card may be either a physical payment card or a virtual payment card. Examples of the payment card include, but are not limited to, a credit card, a debit card, a prepaid card, a gift card, a rewards card, a loyalty points card, a frequent flyer miles card, or the like.

A digital wallet is a financial instrument that facilitates payment transactions. The digital wallet is preloaded with funds. The funds available in the digital wallet is used for payment transactions. Additionally, the funds may be added to the digital wallet from the corresponding payment account. VPA is a unique identifier used for payment transactions. The VPA serves as an alternative to sharing sensitive bank account details (such as the account number and Indian Financial System Code (IFSC) code) during payment transactions.

The plurality of user devices 106 may include a first user device 106a, a second user device 106b, until an nth user device 106n. The plurality of user devices 106 may be associated with the plurality of users 102. The plurality of user devices 106 may facilitate the plurality of users 102 to perform payment transactions by utilizing the plurality of payment modes 104. In numerous embodiments, a payment application may be installed on each user device of the plurality of user devices 106 to facilitate payment transactions. In an example, the first payment mode 104a may be registered or added on the payment application installed on the first user device 106a. Further, the first user device 106a may be utilized by the first user 102a to perform payment transactions by using the first payment mode 104a. Examples of the plurality of user devices 106 include but are not limited to, a mobile phone, a computer, a laptop, a smartphone, a tablet, a phablet, a smartwatch, or the like.

One or more users of the plurality of users 102 may perform payment transactions with one or more merchants of the plurality of merchants 108 for one or more services or products offered by the corresponding one or more merchants. The plurality of merchants 108 may include a first merchant 108a, a second merchant 108b, until an nth merchant 108n. Each merchant of the plurality of merchants 108 may provide one or more services/products. In an example, the first merchant 108a may provide grocery products and the second merchant 108b may provide electronic products. In some embodiments, the plurality of users 102 and the plurality of merchants 108 may be associated with a geographical location.

Each merchant of the plurality of merchants 108 may correspond to an individual or a business entity that offers products and/or services in exchange for payments. Additionally, each merchant of the plurality of merchants 108 may have a merchant payment account maintained at the financial institution such as an acquirer to receive funds. In some embodiments, the plurality of merchant terminals 110 are associated with the plurality of merchants 108. Further, each merchant terminal of the plurality of merchant terminals 110 may be utilized by a corresponding merchant to facilitate payment transactions with one or more users of the plurality of users 102. Examples of the merchant terminal may include but are not limited to a point-of-sale device, a kiosk, or the like.

In certain embodiments, the plurality of merchant terminals 110 may communicate with the plurality of payment modes 104 in a contactless manner or by way of a contact established therebetween. In an exemplary scenario, when the first payment mode 104a is the physical payment card, the first payment mode 104a may be swiped on the first merchant terminal 110a or tapped on the first merchant terminal 110a for performing a payment for the service provided by the first merchant 108a to the first user 102a. In another exemplary scenario, when the first payment mode 104a corresponds to a VPA, the VPA may be input to the first merchant terminal 110a for availing the service from the first merchant 108a. In yet another exemplary scenario, the first merchant terminal 110a may display an optical code. Further, the first user 102a scans the optical code displayed on the first merchant terminal 110a by way of the first user device 106a to avail the service from the first merchant 108a.

The payment network server 112 may include suitable logic, circuitry, interfaces, and/or code, executable by the circuitry that may be configured to perform one or more operations for facilitating fraud detection based on collaborative filtering. The payment network server 112 may be operated by a payment card association, a digital payment service provider, or the like. The payment network server 112 acts as an intermediary between the issuer server 114 and the acquirer server 116 for facilitating seamless transfer of funds associated with payment transactions between the plurality of users 102 and the plurality of merchants 108.

The payment network server 112 may have access to first historical transaction data. The first historical transaction data may include details of a plurality of historical transactions associated with the plurality of payment modes 104 and the plurality of merchants 108 over a first time period. In one example, the first time period may be six months. In another example, the first time period may be ten months. The details of a historical transaction may include a timestamp, a transaction amount, a payment mode identifier, a merchant identifier, a merchant category code, a product/service associated with the historical transaction, a status of the historical transaction (such as declined or successful), an indication whether the historical transaction is fraudulent, or the like.

The payment network server 112 may be configured to segregate the plurality of payment modes 104 into a plurality of payment mode clusters and the plurality of merchants 108 into a plurality of merchant clusters based on the first historical transaction data. The payment network server 112 is configured to perform the following operations for the segregation. The payment network server 112 may create a plurality of payment mode clustering features for each payment mode of the plurality of payment modes 104. Additionally, the payment network server 112 may be further configured to create a plurality of merchant clustering features for each merchant of the plurality of merchants 108. The plurality of payment mode clustering features and the plurality of merchant clustering features are created based on the first historical transaction data.

A trained clustering machine-learning (ML) model may be associated with the payment network server 112. The payment network server 112 may be further configured to execute the trained clustering ML model, based on the created plurality of payment mode clustering features and the created plurality of merchant clustering features. The plurality of payment modes 104 are segregated into the plurality of payment mode clusters and the plurality of merchants 108 are segregated into the plurality of merchant clusters based on the execution of the trained clustering ML model.

The plurality of payment modes 104 are segregated into the plurality of payment mode clusters such that each payment mode cluster of the plurality of payment mode clusters includes a set of similar payment modes. A similarity between the set of similar payment modes may be based on a transaction pattern associated with each similar payment mode of the set of similar payment modes. In one example, a payment mode cluster of the plurality of payment mode clusters may include the set of payment modes that are utilized for performing payment transactions reaching 5000$ every week. Similarly, the plurality of merchants 108 are segregated into the plurality of merchant clusters such that each merchant cluster of the plurality of merchant clusters includes a set of similar merchants. In one example, a merchant cluster of the plurality of merchants 108 includes the set of merchants that have same merchant category code and similar number of payment transactions in a week.

The payment network server 112 is further configured to generate a collaborative filtering (CF) matrix based on the plurality of payment mode clusters, the plurality of merchant clusters, and second historical transaction data. The second historical transaction data may include details of a plurality of historical transactions associated with the plurality of payment modes 104 and the plurality of merchants 108 over a second time period. In an example, the second time period may be 15 days. In another example, the second time period may be one month. In some embodiments, the first historical transaction data and the second historical transaction data are mutually exclusive. In other words, the first historical transaction data is completely different from the second historical transaction data. In some additional embodiments, the first historical transaction data and the second historical transaction data are mutually inclusive. In other words, there exists an overlap between the first historical transaction data and the second historical transaction data. In further additional embodiments, the first historical transaction data and the second historical transaction data are identical.

The CF matrix corresponds to a two-dimensional matrix where each cell of the CF matrix is associated with a payment mode cluster of the plurality of payment mode clusters and a merchant cluster of the plurality of merchant clusters. Each cell of the CF matrix represents a number of payment transactions occurred between the corresponding payment mode cluster and the corresponding merchant cluster. Further, the payment network server 112 may be configured to determine a CF score for each cell of the CF matrix. The CF score may refer to a likelihood of a new payment transaction between the corresponding payment mode cluster and the corresponding merchant cluster.

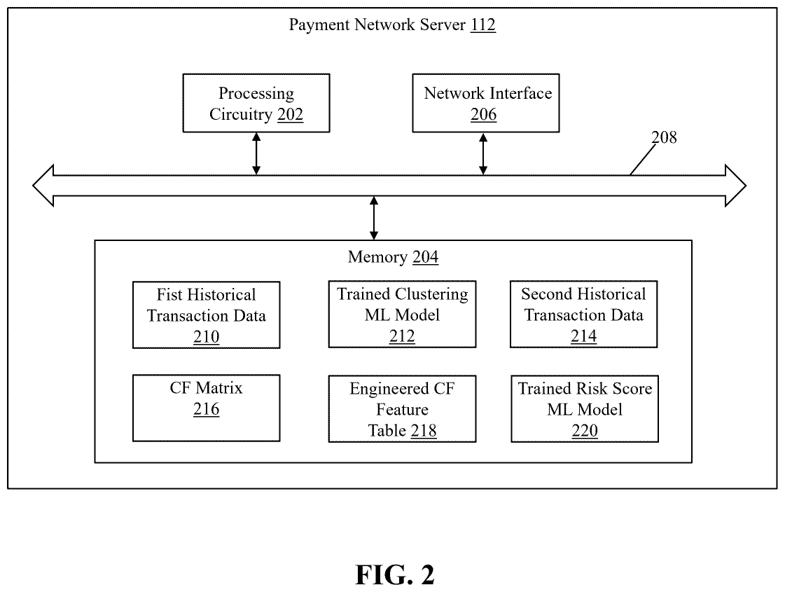

The CF score of each cell of the CF matrix corresponds to a ratio of a corresponding number of transactions between the corresponding payment mode cluster and the corresponding merchant cluster to a sum of a number of transactions of the corresponding payment mode cluster with each of the plurality of merchant clusters. Additionally, the payment network server 112 may be configured to create a plurality of CF feature values for each cell of the CF matrix based on a corresponding CF score and the second historical transaction data. The plurality of CF feature values represent underlying patterns associated with the corresponding payment mode cluster and the corresponding merchant cluster based on the CF matrix. The payment network server 112 may be further configured to store the created plurality of CF values in a memory (shown later in FIG. 2).

The payment network server 112 may be further configured to train a risk score ML model based on the created plurality of CF feature values and a plurality of non-CF feature values. In various embodiments, the plurality of non-CF feature values associated with the plurality of payment modes 104 and the plurality of merchants 108 may be created by the payment network server 112 based on at least the first historical transaction data and the second historical transaction data. The risk score ML model is operable to classify a transaction request as one of a fraudulent transaction request or a legitimate transaction request based on the training. In other words, the risk score ML model is trained to obtain a trained risk score ML model.

The payment network server 112 may be configured to receive a transaction request associated with a target payment mode and a target merchant during an implementation of the trained risk score ML model. The transaction request may be associated with one of a card present transaction, a card not present transaction, an electronic wallet (e-wallet) payment transaction, or a mobile payment transaction. In some embodiments, the target payment mode is one of the plurality of payment modes 104 and the target merchant is one of the plurality of merchants 108. In some further embodiments, the target payment mode is absent in the plurality of payment modes 104 and the target merchant is absent in the plurality of merchants 108.

The payment network server 112 may be configured to identify a target payment mode cluster of the plurality of payment mode clusters that is associated with the target payment mode, and a target merchant cluster of the plurality of merchant clusters that is associated with the target merchant. The payment network server 112 may be further configured to retrieve a target plurality of CF feature values associated with the target payment mode cluster and the target merchant cluster from the memory.

The payment network server 112 may be further configured to input the retrieved plurality of CF feature values and a target plurality of non-CF feature values associated with at least one of the target payment mode and the target merchant, to the trained risk score ML model. In response, the payment network server 112 may be configured to obtain a risk score as an output of the trained risk score ML model. The transaction request is classified as one of a fraudulent transaction request or a legitimate transaction request based on the risk score. The risk score may indicate a level of risk associated with the transaction request. The target plurality of non-CF feature values may be retrieved from the memory. In numerous additional embodiments, the target plurality of non-CF feature values may be created based on historical transactions between the target payment mode and the target merchant.

In a variety of embodiments, the payment network server 112 may be further configured to determine the transaction request as one of the fraudulent transaction request or the legitimate transaction request based on the risk score. In an example, the payment network server 112 may determine the transaction request as the fraudulent transaction request based on the risk score exceeding a threshold value. In such a scenario, the payment network server 112 may be further configured to transmit an alert message to the issuer server 114 associated with the target payment mode. The alert message indicates the issuer server 114 to reject the transaction request. In additional embodiments, the payment network server 112 may be configured to transmit the risk score to the issuer server 114.

In further embodiments, the payment network server 112 may be configured to receive an indication that the transaction request is one of the fraudulent transaction request or the legitimate transaction request from at least one of the issuer server 114 and the acquirer server 116. The indication may be received after the classification. In such a scenario, the payment network server 112 may be further configured to generate a plurality of weights associated with the trained risk score ML model based on the indication. Additionally, the payment network server 112 may be configured to retrain the trained risk score ML model based on the generated plurality of weights. The payment network server 112 is further explained in detail in conjunction with FIG. 2.

The issuer server 114 may include suitable logic, circuitry, interface, and/or code executable by the circuitry, for processing payment transactions. The issuer server 114 is operated by the issuer that maintains the payment account associated with each user of the plurality of users 102. In various embodiments, the issuer server 114 may be configured to receive the alert message associated with the transaction request. Further, the issuer server 114 may be configured to reject the transaction request based on the alert message. In various additional embodiments, the issuer server 114 may be configured to receive the risk score associated with the transaction request along with the transaction request from the payment network server 112. The issuer server 114 may be further configured to reject the transaction request or approve the transaction request based on the risk score.

The acquirer server 116 may include suitable logic, circuitry, interface, and/or code executable by the circuitry for processing payment transactions. The acquirer server 116 is operated by an acquirer that maintains the merchant account associated with each merchant of the plurality of merchants 108. The acquirer server 116 may communicate with the payment network server 112 and the issuer server 114 for processing the payment transactions. In certain embodiments, the acquirer server 116 may be configured to receive the transaction request from a target merchant terminal associated with the target merchant. Further, the acquirer server 116 may transmit the transaction request to the payment network server 112.

Examples of the payment network server 112, the issuer server 114, and the acquirer server 116 may include but are not limited to, computers, laptops, mini-computers, mainframe computers, any non-transient and tangible machines that may execute a machine-readable code, cloud-based servers, distributed server networks, a network of computer systems, or a combination thereof.

The communication network 118 may be a medium through which content and messages are transmitted between the plurality of user devices 106, the plurality of merchant terminals 110, the payment network server 112, the issuer server 114, and the acquirer server 116. Examples of the communication network 118 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a block diagram that illustrates the payment network server 112 of the system environment 100 of FIG. 1, in accordance with an exemplary embodiment of the present disclosure.

The payment network server 112 may include processing circuitry 202, a memory 204, and a network interface 206. The processing circuitry 202, the memory 204, and the network interface 206 may be communicatively coupled to each other by way of a communication bus 208. The memory described in FIG. 1 is hereinafter referred to as the “memory 204”.

The processing circuitry 202 may include suitable logic, circuitry, interface, and/or code, executable by the circuitry, to facilitate fraud detection based on collaborative filtering. The processing circuitry 202 may create the plurality of payment mode clustering features for each payment mode of the plurality of payment modes 104 and the plurality of merchant clustering features for each merchant of the plurality of merchants 108 based on the first historical transaction data (hereinafter referred to as “the first historical transaction data 210”). The plurality of payment mode clustering features and the plurality of merchant clustering features may be collectively referred to as a “plurality of clustering features”. In an exemplary scenario, the plurality of clustering features may include a number and/or amount of fraudulent transactions, a number and/or amount of declined transactions, and a number and/or amount of returned transactions. The plurality of payment mode clustering features may further include a number and/or amount of domestic transactions, a number and/or amount of transactions on weekdays, a number and/or amount of transactions on a weekend, and a number and/or amount of transactions at night. The plurality of payment mode clustering features may additionally include a number and/or amount of transactions in the morning, a number and/or amount of transactions in the afternoon, a number and/or amount of total transactions, a standard deviation of amount of transactions in six months, a maximum transacted amount, or the like.

The processing circuitry 202 may further execute the trained clustering ML model (hereinafter referred to as “the trained clustering ML model 212”) based on the created plurality of payment mode clustering features and the plurality of merchant clustering features. In some embodiments, the processing circuitry 202 may be configured to input the plurality of payment mode clustering features associated with each payment mode of the plurality of payment modes 104 to the trained clustering ML model 212. In response, the processing circuitry 202 may obtain a payment mode cluster identifier as an output of the trained clustering ML model 212.

The processing circuitry 202 may further gather a set of payment modes having the same payment mode cluster identifier into a payment mode cluster. Thus, the plurality of payment modes 104 are segregated into a plurality of payment mode clusters where each payment mode cluster is associated with a corresponding payment mode cluster identifier. Similarly, the processing circuitry 202 may be configured to input the plurality of merchant clustering features associated with each merchant of the plurality of merchants 108 to the trained clustering ML model 212. In response, the processing circuitry 202 may obtain a merchant cluster identifier as an output of the trained clustering ML model 212. Further, the processing circuitry 202 may gather a set of merchants having the same merchant cluster identifier into a merchant cluster. Thus, the plurality of merchants 108 are segregated into a plurality of merchant clusters where each merchant cluster is associated with a corresponding merchant cluster identifier.

In some further embodiments, the processing circuitry 202 may input the plurality of payment mode clustering features associated with each payment mode of the plurality of payment modes 104 to the trained clustering ML model 212. In response, the processing circuitry 202 may obtain the plurality of payment mode clusters as an output of the trained clustering ML model 212. Similarly, the processing circuitry 202 may input the plurality of merchant clustering features associated with each merchant of the plurality of merchants 108 to the trained clustering ML model 212. In response, the processing circuitry 202 may obtain the plurality of merchant clusters as an output of the trained clustering ML model 212. Each merchant cluster of the plurality of merchant clusters is associated with a merchant transaction pattern and each payment mode cluster of the plurality of payment mode clusters is associated with a payment mode transaction pattern. Each payment mode transaction pattern may be associated with a predefined plurality of values for the plurality of payment mode clustering features such that the set of similar payment modes are segregated into a payment mode cluster. Similarly, each merchant transaction pattern may be associated with a predefined plurality of values for the plurality of merchant clustering features such that the set of similar merchants are segregated into a merchant cluster. In additional embodiments, the processing circuitry 202 may store the plurality of payment mode clusters and the plurality of merchant clusters in the memory 204. In numerous additional embodiments, the processing circuitry 202 may train a clustering ML model to obtain the trained clustering ML model 212. In further additional embodiments, the clustering ML model may be trained by a third-party entity and the trained clustering ML model 212 may be provided to the payment network server 112.

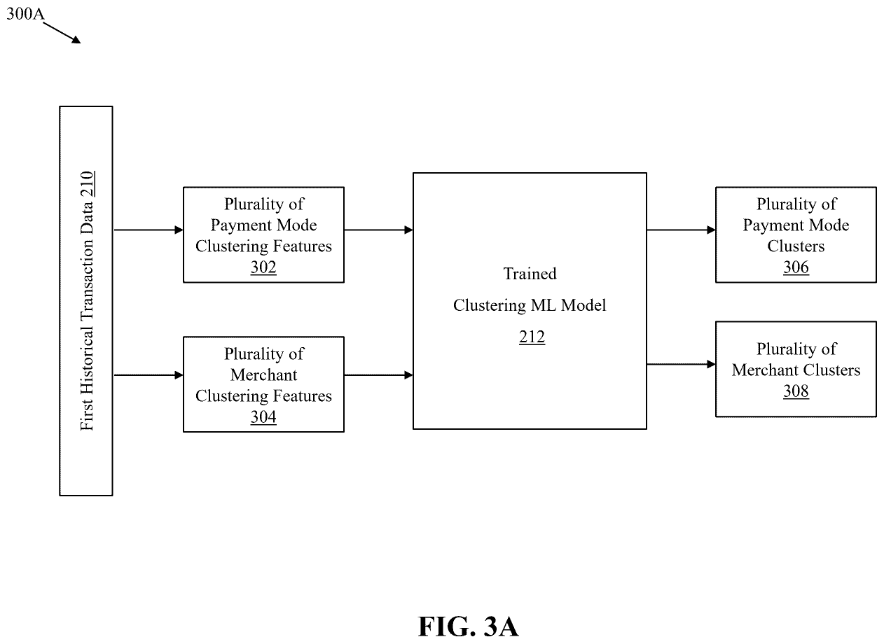

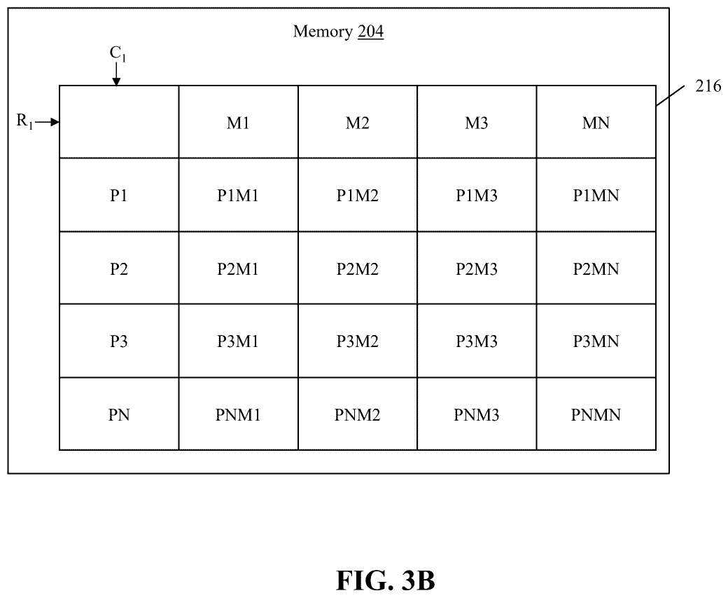

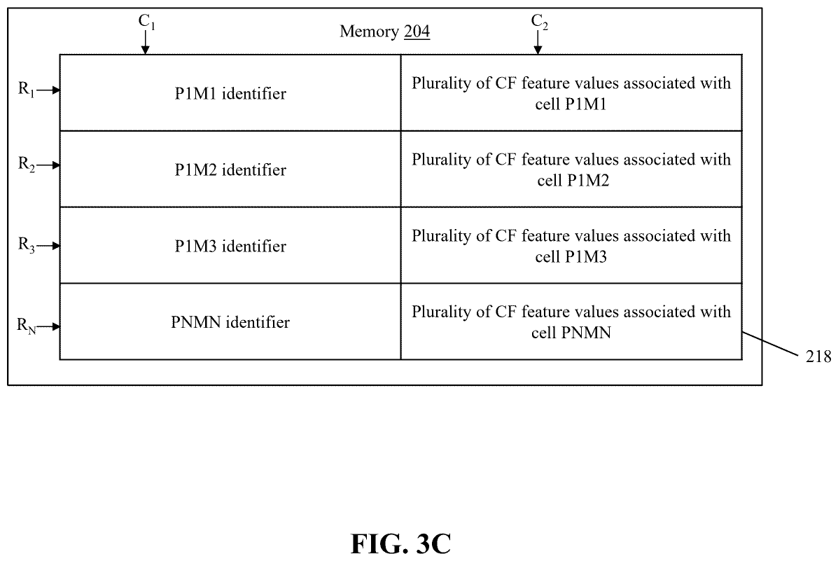

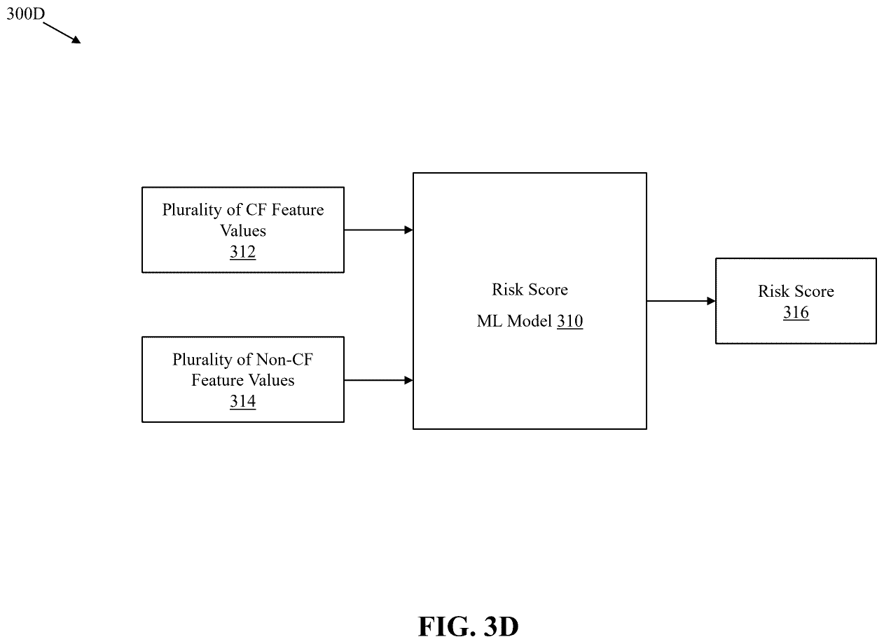

The processing circuitry 202 may further generate the CF matrix (hereinafter referred to as “the CF matrix 216”) based on the plurality of payment mode clusters, the plurality of merchant clusters, and the second historical transaction data (hereinafter referred to as the “second historical transaction data 214”). Each cell of the CF matrix 216 is indicative of the number of transactions between the corresponding payment mode cluster of the plurality of payment mode clusters and the corresponding merchant cluster of the plurality of merchant clusters. The number of transactions between the corresponding payment mode cluster and the corresponding merchant cluster are obtained from the second historical transaction data 214. The CF matrix 216 is further explained in detail in conjunction with FIG. 3B.

The processing circuitry 202 may further determine the CF score for each cell of the CF matrix 216. Thus, each payment mode cluster-merchant cluster pair of the CF matrix 216 is associated with a corresponding CF score. The CF score of each cell of the CF matrix 216 corresponds to a ratio of a corresponding number of transactions between the corresponding payment mode cluster and the corresponding merchant cluster to a sum of a number of transactions of the corresponding payment mode cluster with each of the plurality of merchant clusters. The CF score may refer to a likelihood score for a payment transaction between the corresponding payment mode cluster-merchant cluster pair.

The processing circuitry 202 may further create the plurality of CF feature values for each cell of the CF matrix 216 based on the CF score and the second historical transaction data 214. Further, the processing circuitry 202 may store the plurality of CF feature values of each cell of the CF matrix 216 in an engineered CF feature table 218 in the memory 204. The engineered CF feature table 218 is described in detail in conjunction with FIG. 3C. Further, the processing circuitry 202 may further train the risk score ML model based on the created plurality of CF feature values and the plurality of non-CF feature values. The plurality of non-CF feature values may be associated with the plurality of payment modes 104 and the plurality of merchants 108. In various embodiments, the processing circuitry 202 may obtain the plurality of non-CF feature values based on the first historical transaction data 210. The processing circuitry 202 may further store the risk score ML model that is trained as the trained risk score ML model 220 in the memory 204. The trained risk score ML model 220 is operable to classify a transaction request as one of a fraudulent transaction request or a legitimate transaction request based on the training.

The processing circuitry 202 may utilize the engineered CF feature table 218 and the trained risk score ML model 220 to detect fraud in real-time payment transactions based on collaborative filtering. The processing circuitry 202 may receive the transaction request associated with the target payment mode and the target merchant. The processing circuitry 202 may identify the target payment mode cluster from the plurality of payment mode clusters that is associated with the target payment mode and the target merchant cluster from the plurality of merchant clusters that is associated with the target merchant. In numerous embodiments, the processing circuitry 202 may create a plurality of target clustering features associated with the target payment mode and the target merchant. Further, the processing circuitry 202 may utilize the trained clustering ML model 212 to identify the target payment mode cluster and the target merchant cluster based on the plurality of target clustering features.

The processing circuitry 202 may retrieve the target plurality of CF feature values associated with the target payment mode cluster and the target merchant cluster from the engineered CF feature table 218 stored in the memory 204. Further, the processing circuitry 202 may input the retrieved plurality of CF feature values and the target plurality of non-CF feature values associated with at least one of the target payment mode and the target merchant, to the trained risk score ML model 220. Further, the processing circuitry 202 may obtain the risk score associated with the transaction request as the output of the trained risk score ML model 220. The transaction request is classified as one of a fraudulent transaction request or a legitimate transaction request based on the risk score. The risk score may indicate a level of risk associated with the transaction request.

The memory 204 may include suitable logic, circuitry, and/or interfaces to store various instructions, tables, ML models, or the like to facilitate fraud detection based on collaborative filtering. For example, the memory 204 may store the first historical transaction data 210, the trained clustering ML model 212, the second historical transaction data 214, the CF matrix 216, the engineered CF feature table 218, and the trained risk score ML model 220. Examples of the memory 204 may include a random-access memory (RAM), a read-only memory (ROM), a programmable ROM (PROM), an erasable PROM (EPROM), a removable storage drive, a hard disk drive (HDD), a flash memory, a solid-state memory, or the like.

The network interface 206 may include suitable logic, circuitry, interfaces, and/or code, executable by the circuitry, to transmit and receive data over the communication network 118 using one or more communication network protocols. Examples of the network interface 206 may include but are not limited to, an antenna, a radio frequency transceiver, a wireless transceiver, a Bluetooth transceiver, an ethernet port, a USB port, or any other device configured to transmit and receive data.

FIG. 3A represents a block diagram 300A that illustrates the segregation of the plurality of payment modes 104 into the plurality of payment mode clusters and the plurality of merchants 108 into the plurality of merchant clusters, in accordance with an exemplary embodiment of the present disclosure.

The processing circuitry 202 retrieves the first historical transaction data 210 from the memory 204. The first historical transaction data 210 includes the details of the plurality of historical transactions associated with the plurality of payment modes 104 and the plurality of merchants 108. In an exemplary scenario, a number of payment modes in the plurality of payment modes 104 is assumed to be ‘10,000’ and a number of merchants in the plurality of merchants 108 is assumed to be ‘2000’. The processing circuitry 202 further creates the plurality of payment mode clustering features for each payment mode of the plurality of payment modes 104 and the plurality of merchant clustering features for each merchant of the plurality of merchants 108 based on the first historical transaction data 210.

In an exemplary scenario, the plurality of clustering features may include a number and/or amount of fraudulent transactions, a number and/or amount of declined transactions, and a number and/or amount of returned transactions. The plurality of payment mode clustering features may further include a number and/or amount of domestic transactions, a number and/or amount of transactions on weekdays, a number and/or amount of transactions on weekend, and a number and/or amount of transactions at night. The plurality of payment mode clustering features may additionally include a number and/or amount of transactions in the morning, a number and/or amount of transactions in the afternoon, a number and/or amount of total transactions, a standard deviation of amount of transactions in six months, a maximum transacted amount, or the like. The plurality of payment mode clustering features created for each payment mode of the plurality of payment modes 104 may be collectively referred to as “the plurality of payment mode clustering features 302”. Similarly, the plurality of merchant clustering features created for each merchant of the plurality of merchants 108 may be collectively referred to as “the plurality of merchant clustering features 304”

The trained clustering ML model 212 refers to a model that is realized by one or more machine-learning algorithms that are trained to output the plurality of payment mode clusters and the plurality of merchant clusters based on the plurality of payment mode clustering features 302 and the plurality of merchant clustering features 304. Examples of a machine-learning algorithm may include but are not limited to, K-means clustering, hierarchical clustering, decision trees, neural networks, or the like

The processing circuitry 202 may input the plurality of payment mode clustering features 302 and the plurality of merchant clustering features 304 to the trained clustering ML model 212. Further, the trained clustering ML model 212 may output the plurality of payment mode clusters (hereinafter referred to as “the plurality of payment mode clusters 306”) and the plurality of merchant clusters (hereinafter referred to as “the plurality of merchant clusters 308”). In an exemplary scenario, 10,000 payment modes may be segregated into 10 payment mode clusters such that 10,000 payment modes are divided across 10 payment mode clusters. Similarly, 2000 merchants may be segregated into 10 merchant clusters such that 2000 merchants are divided across the 10 merchant clusters.

The plurality of payment modes 104 are segregated into the plurality of payment mode clusters 306 such that each payment mode cluster includes the set of similar payment modes. The set of similar payment modes includes one or more payment modes of the plurality of payment modes 104 that share a similar payment mode transaction pattern. For example, one payment mode cluster of the plurality of payment mode clusters 306 may include the set of similar payment modes where each similar payment mode has an average transaction value in a range of 200$ to 500$ on weekends. Further, another payment mode cluster of the plurality of payment mode clusters 306 may include the set of similar payment modes where each similar payment mode has more than 20 declined transactions.

The plurality of merchants 108 are segregated into the plurality of merchant clusters 308 such that each merchant cluster includes the set of similar merchants. The set of similar merchants includes one or more merchants of the plurality of merchants 108 that share a similar merchant transaction pattern. For example, one merchant cluster of the plurality of merchant clusters 308 may include the set of similar merchants where each merchant has an average transaction value in a range of 20000$ to 25000$ on weekends. Further, another merchant cluster of the plurality of merchant clusters 308 may include the set of similar merchants where each similar merchant is associated with a same merchant category code.

FIG. 3B illustrates the CF matrix 216 generated based on the plurality of payment mode clusters 306 and the plurality of merchant clusters 308, in accordance with an exemplary embodiment of the present disclosure.

The CF matrix 216 corresponds to a two-dimensional matrix that represents interaction between the plurality of payment mode clusters 306 and the plurality of merchant clusters 308. The CF matrix 216 may include a plurality of rows and a plurality of columns. A first row of the plurality of rows includes a plurality of merchant clusters M1-MN and a first column of the plurality of columns includes a plurality of payment mode clusters P1-PN. The plurality of payment mode clusters 306 may be alternatively referred to as “the plurality of payment mode clusters P1-PN”. Additionally, the plurality of merchant clusters 308 may be alternatively referred to as “the plurality of merchant clusters M1-MN”. The plurality of merchant clusters M1-MN is shown to include a first merchant cluster M1, a second merchant cluster M2, a third merchant cluster M3, until an Nth merchant cluster MN. Similarly, the plurality of payment mode clusters P1-PN is shown to include a first payment mode cluster P1, a second payment mode cluster P2, a third payment mode cluster P1, until an Nth payment mode cluster PN.

The processing circuitry 202 generates the CF matrix 216 such that each cell of the CF matrix 216 excluding the first row R1 and first column C1 represents the number of transactions between the corresponding payment mode cluster of the plurality of payment mode clusters P1-PN and the corresponding merchant cluster of the plurality of merchant clusters M1-MN. The CF matrix 216 is further shown to include cells P1M1-PNMN. The cell P1M1 represents a number of transactions between the first payment mode cluster P1 and the first merchant cluster M1. The cell P1M2 represents a number of transactions between the first payment mode cluster P1 and the second merchant cluster M2. The cell P1M3 represents a number of transactions between the first payment mode cluster P1 and the third merchant cluster M3 and the cell P1MN represents a number of transactions between the first payment mode cluster P1 and the Nth merchant cluster MN.

The cell P2M1 represents a number of transactions between the second payment mode cluster P2 and the first merchant cluster M1 and the cell P2M2 represents a number of transactions between the second payment mode cluster P2 and the second merchant cluster M2. Similarly, the cell P2M3 represents a number of transactions between the second payment mode cluster P2 and the third merchant cluster M3 and the cell P2MN represents a number of transactions between the second payment mode cluster P2 and the Nth merchant cluster MN. Further, the cell P3M1 represents a number of transactions between the third payment mode cluster P3 and the first merchant cluster M1 and the cell P3M2 represents a number of transactions between the third payment mode cluster P3 and the second merchant cluster M2. Similarly, the cell P3M3 represents a number of transactions between the third payment mode cluster P3 and the third merchant cluster M3 and the cell P3MN represents a number of transactions between the third payment mode cluster P3 and the Nth merchant cluster MN.

The cell PNM1 represents a number of transactions between the Nth payment mode cluster PN and the first merchant cluster M1 and the cell PNM2 represents a number of transactions between the Nth payment mode cluster PN and the second merchant cluster M2. Similarly, the cell PNM3 represents a number of transactions between the Nth payment mode cluster PN and the third merchant cluster M3 and the cell PNMN represents a number of transactions between the Nth payment mode cluster PN and the Nth merchant cluster MN.

The plurality of cells P1M1-PNMN are filled by the processing circuitry 202 based on the second historical transaction data 214. In various embodiments, the processing circuitry 202 may be configured to refresh the CF matrix 216 periodically. In one example, the plurality of cells P 1M1-PNMM may be refreshed every 15 days. In another example, the plurality of cells P 1M1-PNMM may be refreshed every 25 days.

The processing circuitry 202 may further determine the CF score for each cell of the plurality of cells P1M1-PNMN. The CF score of a cell of the plurality of cells P1M1-PNMN corresponds to a ratio of a value associated with the corresponding cell to a summation of values associated with the corresponding row. For example, the CF score of the cell P1M1 corresponds to a ratio of the number of transactions represented in the cell P1M1 to a sum of number of transactions represented by the cells P1M1, P1M2, P1M3, and P1MN. In other words, a numerator of the above-described ratio represents the number of transactions occurred between the first payment mode cluster P1 and the first merchant cluster M1. Further, a denominator of the above-described ratio represents a total number of transactions between the first payment mode cluster P1 and the plurality of merchant clusters M1-MN.

The processing circuitry 202 may further create the plurality of CF feature values for each cell of the CF matrix 216 based on the corresponding CF score and the second historical transaction data 214. The processing circuitry 202 may store the plurality of CF feature values of each cell of the CF matrix 216 in a form of the engineered CF feature table 218 in the memory 204.

FIG. 3C illustrates the engineered CF feature table 218 stored in the memory 204 of the payment network server 112 in accordance with an exemplary embodiment of the present disclosure.

The engineered CF feature table 218 is a structured table that includes a first column C1, a second column C2, and a plurality of rows. The plurality of rows is shown to include a first row R1, a second row R2, a third row R3, until an nth row RN. In the first column C1, the first row R1 represents a P1M1 identifier associated with the cell P1M1. Further, the second row R2 represents a P1M2 identifier associated with the cell P1M2, the third row R3 represents a P1M3 identifier associated with the cell P1M3, and the Nth row RN represents a PNMN identifier associated with the cell PNMN. In other words, each row of the first column C1 represents the identifier associated with a corresponding payment mode cluster-merchant cluster pair.

In the second column C2, the first row R1 represents the plurality of CF feature values associated with the cell P1M1 and the second row R2 represents the plurality of CF feature values associated with the cell P1M2. Similarly, the third row R3 represents the plurality of CF feature values associated with the cell P1M3 and the Nth row PNMN represents the plurality of CF feature values associated with the cell N1MN.

In some embodiments, the plurality of CF feature values for each cell of the plurality of cells P1M1-PNMN may include a plurality of lag-based features, a plurality of sum-based features, and a plurality of ratio-based features. The plurality of lag-based features include at least one of (i) a product of a logarithm of the CF score of the corresponding cell and each of a first set of historical transaction amounts, (ii) approved historical transaction amounts of the first set of historical transaction amounts, (iii) an intersection of (i) and (ii), and the like. The first set of historical transaction amounts may include a last historical transaction amount, a sum of last two historical transaction amounts, a sum of last three historical transaction amounts, until a sum of nth historical transaction amounts.

The plurality of sum-based features may include at least one of (i) a product of a logarithm of the CF score of the corresponding cell and each of a second set of historical transaction amounts, (ii) approved historical transaction amounts of the second set of historical transaction amounts, (iii) an intersection of (i) and (ii), and the like. The second set of historical transaction amounts may include a sum of transaction amounts associated with transactions that occurred in last 15 minutes, a sum of transaction amounts associated with transactions occurred in last day, a sum of amounts associated with transactions that occurred in last hour, until a sum of amounts associated with transactions occurred in an nth time period.

The plurality of ratio features may include at least one of (i) a product of a logarithm of the CF score of the corresponding cell and each of a third set of historical transaction amounts, (ii) approved historical transaction amounts of the third set of historical transaction amounts, (iii) an intersection of (i) and (ii), and the like. The third set of historical transaction amounts may include a set of ratios that is obtained based on the second set of historical transaction amounts. In a non-limiting example, the plurality of CF feature values of each payment mode cluster-merchant cluster pair is assumed to include 61 features.

FIG. 3D is a block diagram 300D that illustrates training of the risk score ML model by the payment network server 112 in accordance with an exemplary embodiment of the present disclosure. The block diagram 300D is shown to include the risk score ML model referred to as “the risk score ML model 310”. The processing circuitry 202 may input the created plurality of CF feature values referred to as “the plurality of CF feature values 312” and the plurality of non-CF feature values referred to as “the plurality of non-CF feature values 314” to the risk score ML model 310. The plurality of CF feature values 312 includes the plurality of CF feature values associated with the cell P1M1 through the cell PNMN. Further, the plurality of non-CF feature values 314 may be obtained based on the second historical transaction data 214 associated with the plurality of payment modes 104 and the plurality of merchants 108.

The risk score ML model 310 learns weights and biases for each payment mode of the plurality of payment modes 104 and each merchant of the plurality of merchants 108 based on the inputs. Further, the risk score ML model 310 learns to determine a risk score for a transaction request associated with a payment mode and a merchant based on the learnt weights and biases. In some embodiments, the plurality of CF feature values 312 and the plurality of non-CF feature values 314 may be divided into training dataset and testing dataset. In such embodiments, the processing circuitry 202 may train the risk score ML model 310 based on the training dataset. Further, the processing circuitry 202 may test the risk score ML model 310 based on the testing dataset to determine an accuracy of the risk score ML model 310. In various embodiments, the processing circuitry 202 may train the risk score ML model 310 until the accuracy of the risk score ML model 310 exceeds a threshold limit. Thus, the trained risk score ML model 220 is obtained based on the training. The processing circuitry 202 may further store the trained risk score ML model 220 in the memory 204.

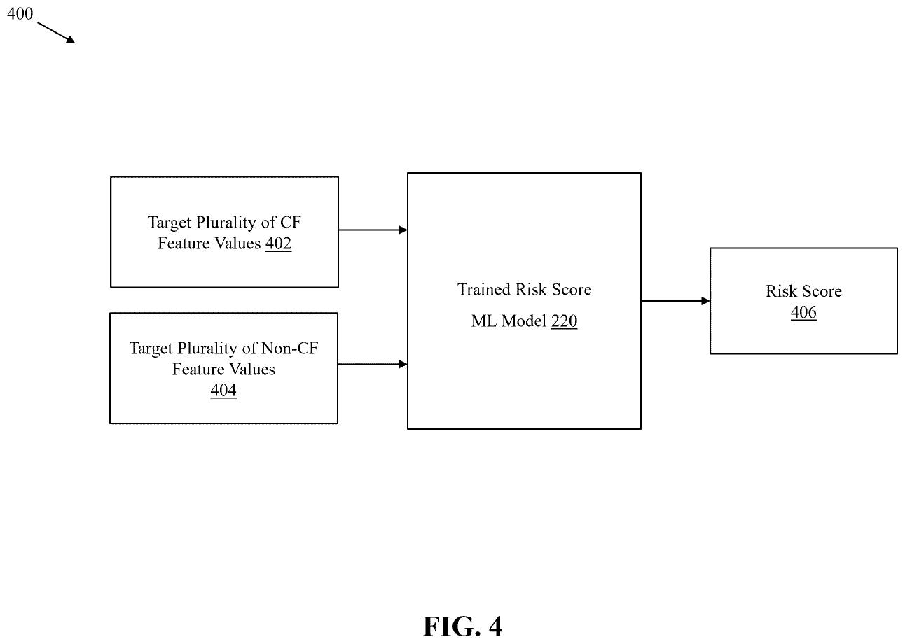

FIG. 4 is a block diagram 400 that illustrates implementation of the trained risk score ML model 220 by the processing circuitry 202 of the payment network server 112 in accordance with an exemplary embodiment of the present disclosure.

The processing circuitry 202 receives the transaction request during the implementation of the trained risk score ML model 220. The transaction request is indicative of a transaction initiated between the target payment mode and the target merchant. Further, the processing circuitry 202 may identify the target payment mode cluster that is associated with the target payment mode from the plurality of payment mode clusters 306 and the target merchant cluster that is associated with the target merchant from the plurality of merchant clusters 308. Further, the processing circuitry 202 may identify the identifier associated with the target payment mode cluster-target merchant cluster pair.

The processing circuitry 202 may further retrieve the target plurality of CF feature values (hereinafter referred to as “the target plurality of CF feature values 402”) associated with the target payment mode cluster-target merchant cluster pair from the engineered CF feature table 218 stored in the memory 204 based on the identified identifier. Further, the processing circuitry 202 may input the retrieved plurality of CF feature values and the target plurality of non-CF feature values (hereinafter referred to as “the target plurality of non-CF feature values 404”) associated with at least one of the target payment mode and the target merchant, to the trained risk score ML model 220. The trained risk score ML model 220 may determine the risk score 406 for the transaction request based on the received inputs. Further, the processing circuitry 202 may obtain the risk score 406 associated with the transaction request as the output of the trained risk score ML model 220.

In a variety of embodiments, the processing circuitry 202 may further determine the transaction request as one of the fraudulent transaction request and the legitimate transaction request based on the risk score 406. In an example, the processing circuitry 202 may determine the transaction request as the fraudulent transaction request based on the risk score 406 exceeding a threshold value. In such a scenario, the processing circuitry 202 may transmit the alert message to the issuer server 114 associated with the target payment mode. The alert message indicates the issuer server 114 to reject the transaction request.

In further embodiments, the processing circuitry 202 may receive the indication that the transaction request is one of the fraudulent transaction request or the legitimate transaction request from the issuer server 114. In such a scenario, the processing circuitry 202 may generate the plurality of weights associated with the trained risk score ML model 220 based on the indication. Additionally, the payment network server 112 may be configured to retrain the trained risk score ML model 220 based on the generated plurality of weights to improve the accuracy of the trained risk score ML model 220.

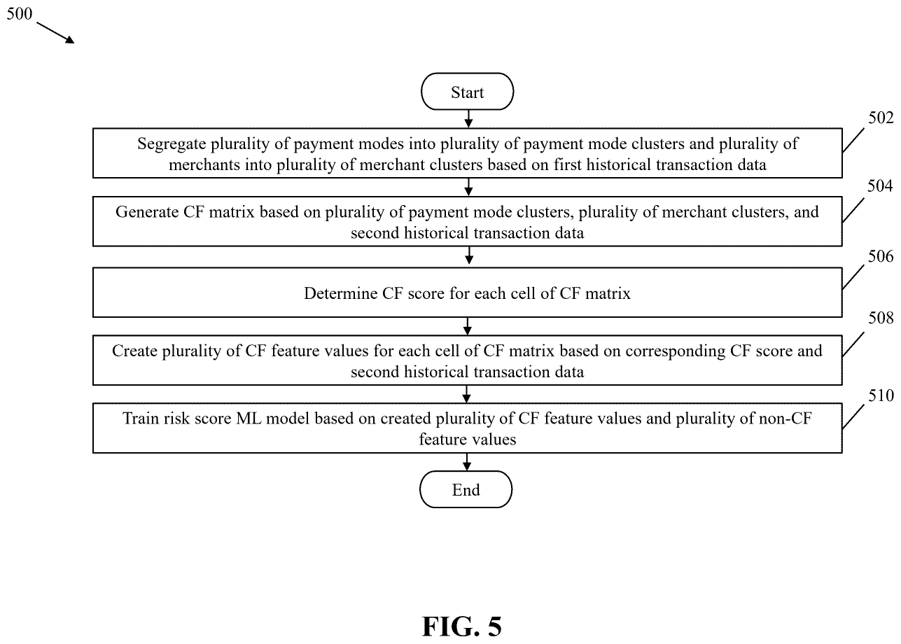

FIG. 5 represents a high-level flowchart 500 that illustrates a method (e.g., a process 500) for training the risk score ML model 310 by the payment network server 112, in accordance with an exemplary embodiment of the present disclosure.

At 502, the plurality of payment modes 104 are segregated into the plurality of payment mode clusters 306 and the plurality of merchants 108 are segregated into the plurality of merchant clusters 308 by the payment network server 112 based on the first historical transaction data 210. Each payment mode cluster of the plurality of payment mode clusters 306 includes the set of similar payment modes and each merchant cluster of the plurality of merchant clusters 308 includes the set of similar merchants.

At 504, the CF matrix 216 is generated by the payment network server 112 based on the plurality of payment mode clusters 306, the plurality of merchant clusters 308, and the second historical transaction data 214. Each cell of the CF matrix 216 represents the number of transactions associated with the corresponding payment mode cluster and the corresponding merchant cluster.

At 506, the CF score for each cell of the CF matrix 216 is determined by the payment network server 112 based on the corresponding cell of the CF matrix 216. The CF score corresponds to the ratio of number of transactions between the corresponding payment mode cluster and the corresponding merchant cluster to the sum of the number of transactions of the corresponding payment mode cluster with each of the plurality of merchant clusters 308.

At 508, the plurality of CF feature values for each cell for the CF matrix 216 is created by the payment network server 112 based on the corresponding CF score and the second historical transaction data 214. At 510, the risk score ML model 310 is trained by the payment network server 112 based on the created plurality of CF feature values 312 and the plurality of non-CF feature values 314. The plurality of non-CF feature values 314 are associated with the plurality of payment modes 104 and/or the plurality of merchants 108. The risk score ML model 310 is operable to classify a transaction request as one of a fraudulent transaction request or a legitimate transaction request based on the training.

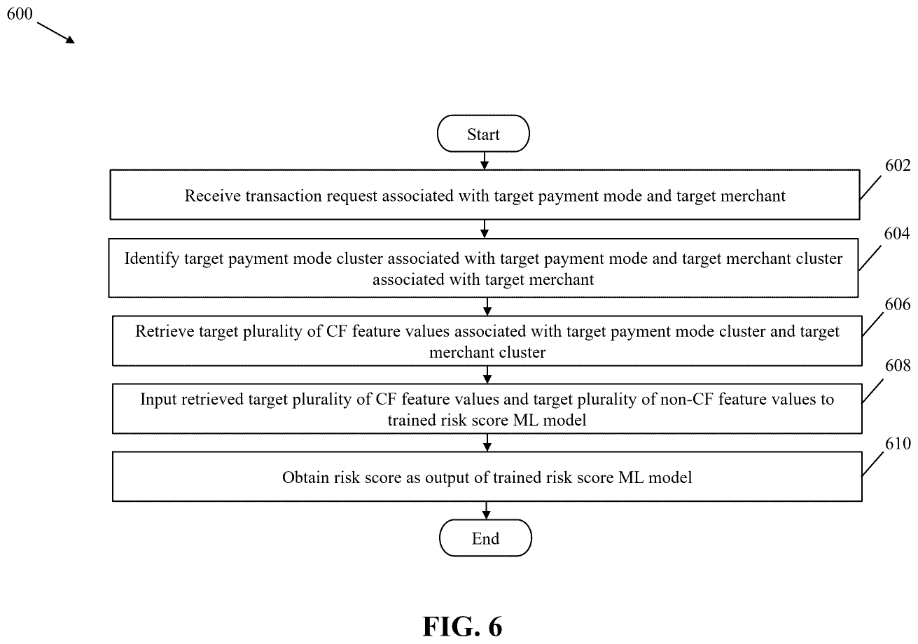

FIG. 6 represents a high-level flowchart 600 that illustrates a method (e.g., a process 600) for facilitating fraud detection based on collaborative filtering by the payment network server 112, in accordance with an exemplary embodiment of the present disclosure.

At 602, the transaction request associated with the target payment mode and the target merchant is received by the payment network server 112. The transaction request is associated with the transaction initiated between the target merchant and the target payment mode.

At 604, the target payment mode cluster associated with the target payment mode and the target merchant cluster associated with the target merchant are identified by the payment network server 112. The target payment mode cluster corresponds to one of the plurality of payment mode clusters 306. Similarly, the target merchant cluster corresponds to one of the plurality of merchant clusters 308.

At 606, the target plurality of CF feature values 402 associated with the target payment mode cluster and the target merchant cluster are retrieved from the memory 204 by the payment network server 112. The target plurality of CF feature values 402 are retrieved from the engineered CF feature table 218 stored in the memory 204. At 608, the target plurality of CF feature values 402 and the target plurality of non-CF feature values 404 are input to the trained risk score ML model 220 by the payment network server 112. The plurality of non-CF feature values may be associated with at least one of the target payment mode and the target merchant.

At 610, the risk score 406 is obtained as the output from the trained risk score ML model 220 by the payment network server 112. The transaction request is classified as one of the fraudulent transaction request and the legitimate transaction request based on the risk score 406.

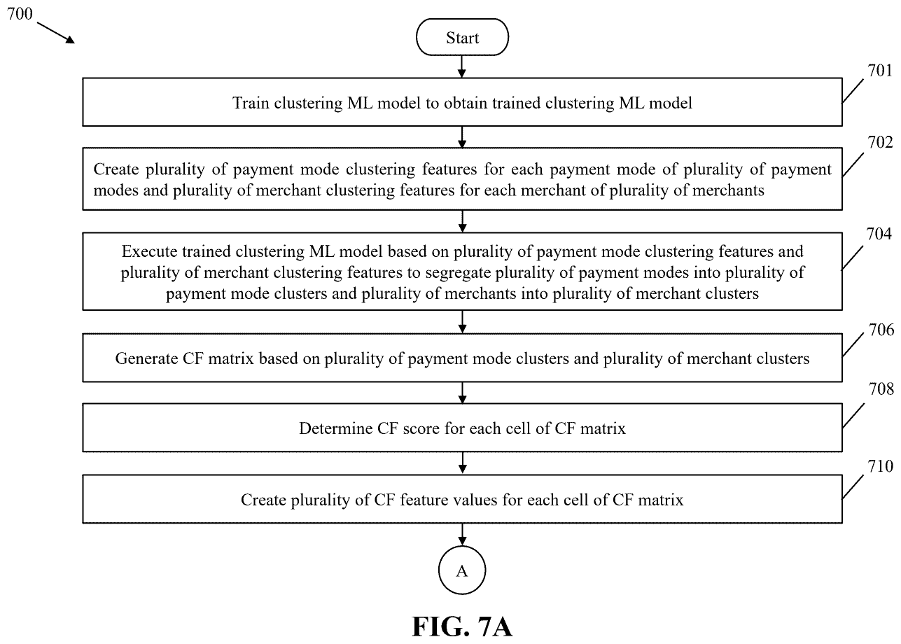

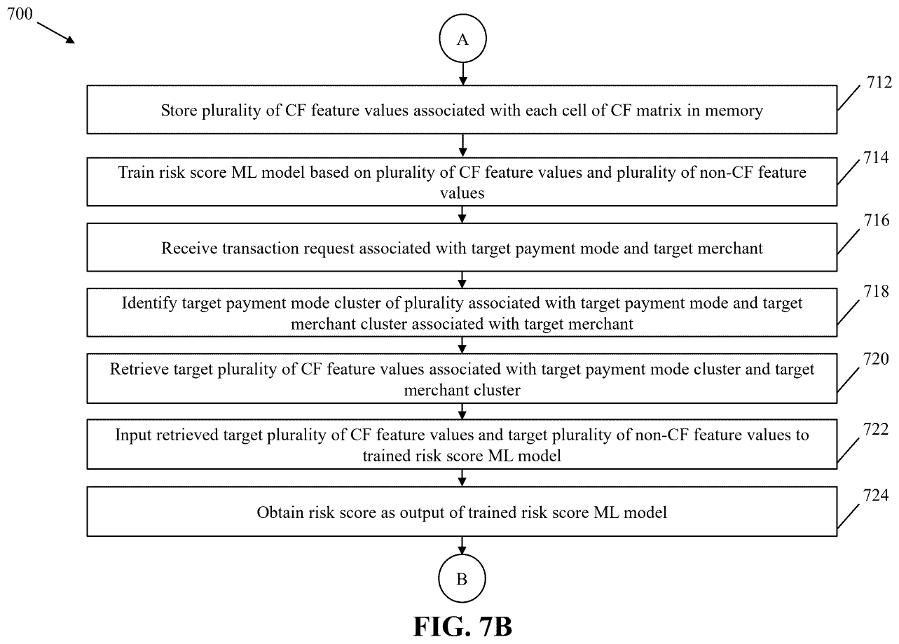

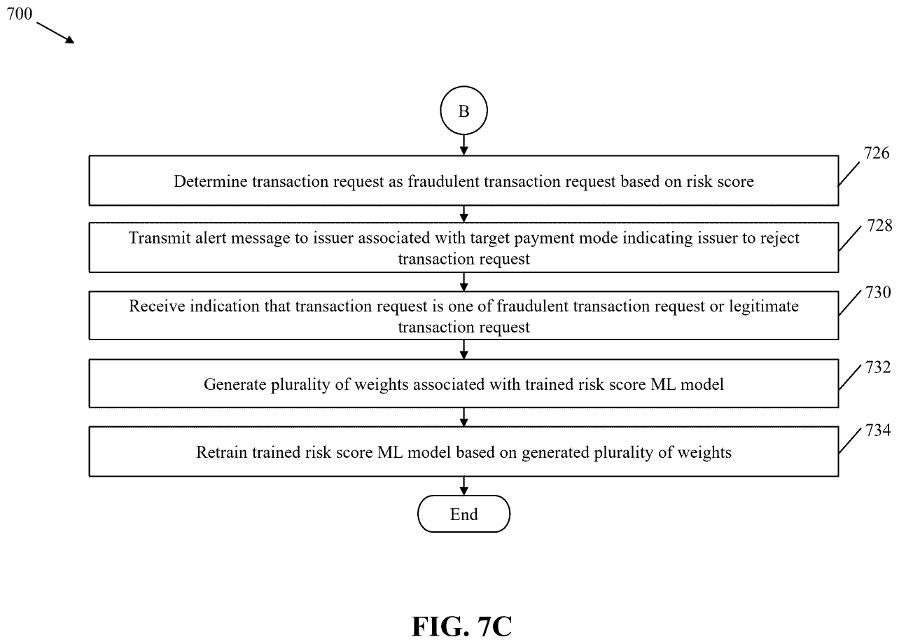

FIGS. 7A-7C, collectively, represents a flowchart 700 that illustrates a method (e.g., a process 700) for facilitating fraud detection based on collaborative filtering by the payment network server 112, in accordance with an exemplary embodiment of the present disclosure.

Referring to FIG. 7A, at 701, the clustering ML model is trained by the payment network server 112 to obtain the trained clustering ML model 212. At 702, the plurality of payment mode clustering features for each payment mode of the plurality of payment modes 104 and the plurality of merchant clustering features for each merchant of the plurality of merchants 108 are created based on the first historical transaction data 210, by the payment network server 112. At 704, the trained clustering ML model 212 is executed based on the created plurality of payment mode clustering features 302 and the created plurality of merchant clustering features 304, by the payment network server 112. The plurality of payment modes 104 are segregated into the plurality of payment mode clusters 306 and the plurality of merchants 108 are segregated into the plurality of merchant clusters 308 based on the execution of the trained clustering ML model 212.

At 706, the CF matrix 216 is generated by the payment network server 112 based on the plurality of payment mode clusters 306, the plurality of merchant clusters 308, and the second historical transaction data 214. Each cell of the CF matrix 216 represents the number of transactions associated with the corresponding payment mode cluster and the corresponding merchant cluster.

At 708, the CF score for each cell of the CF matrix 216 is determined by the payment network server 112 based on the corresponding cell of the CF matrix 216. The CF score corresponds to the ratio of number of transactions between the corresponding payment mode cluster and the corresponding merchant cluster to the sum of the number of transactions of the corresponding payment mode cluster with each of the plurality of merchant clusters 308.

At 710, the plurality of CF feature values for each cell for the CF matrix 216 is created by the payment network server 112 based on the corresponding CF score and the second historical transaction data 214.

Referring to FIG. 7B, At 712, the plurality of CF feature values associated with each cell of the CF matrix 216 are stored in the memory 204 by the payment network server 112. The plurality of CF feature values associated with each cell of the CF matrix 216 are stored in the engineered CF feature table 218 in the memory 204.

At 714, the risk score ML model 310 is trained by the payment network server 112 based on the created plurality of CF feature values 312 and the plurality of non-CF feature values 314. The plurality of non-CF feature values 314 are associated with the plurality of payment modes 104 and/or the plurality of merchants 108.

At 716, the transaction request associated with the target payment mode and the target merchant is received by the payment network server 112. The transaction request is associated with the transaction initiated between the target merchant and the target payment mode. At 718, the target payment mode cluster associated with the target payment mode and the target merchant cluster associated with the target merchant are identified by the payment network server 112. The target payment mode cluster corresponds to one of the plurality of payment mode clusters 306. Similarly, the target merchant cluster corresponds to one of the plurality of merchant clusters 308.

At 720, the target plurality of CF feature values 402 associated with the target payment mode cluster and the target merchant cluster are retrieved from the memory 204, by the payment network server 112. The target plurality of CF feature values 402 are retrieved from the engineered CF feature table 218 stored in the memory 204. At 722, the target plurality of CF feature values 402 and the target plurality of non-CF feature values 404 are input to the trained risk score ML model 220 by the payment network server 112. The target plurality of non-CF feature values 404 may be associated with at least one of the target payment mode and the target merchant.

At 724, the risk score 406 is obtained as the output from the trained risk score ML model 220 by the payment network server 112. The transaction request is classified as one of the fraudulent transaction request and the legitimate transaction request based on the risk score 406. The risk score 406 is used to classify the transaction request as one of the fraudulent transaction request or the legitimate transaction request.

Referring to FIG. 7C, at 726, the transaction request is determined as the fraudulent transaction request based on the risk score 406, by the payment network server 112. In an example, the transaction request is determined as the fraudulent transaction request based on the risk score 406 exceeding the threshold value.

At 728, the alert message is transmitted to the issuer server 114 by the payment network server 112 indicating the issuer to reject the transaction request. At 730, the indication that the transaction request is one of the fraudulent transaction request or the legitimate transaction request is received by the payment network server 112. The indication may be received from at least one of the issuer server 114 and the acquirer server 116 based on the processing of the transaction request. The payment network server 112 may validate whether the determination that the transaction request is fraudulent is successful.

At 732, the plurality of weights associated with the trained risk score ML model 220 is generated, by the payment network server 112. At 734, the trained risk score ML model 220 is retrained based on the generated plurality of weights, by the payment network server 112. The retraining aids in improving the accuracy of the trained risk score ML model 220.

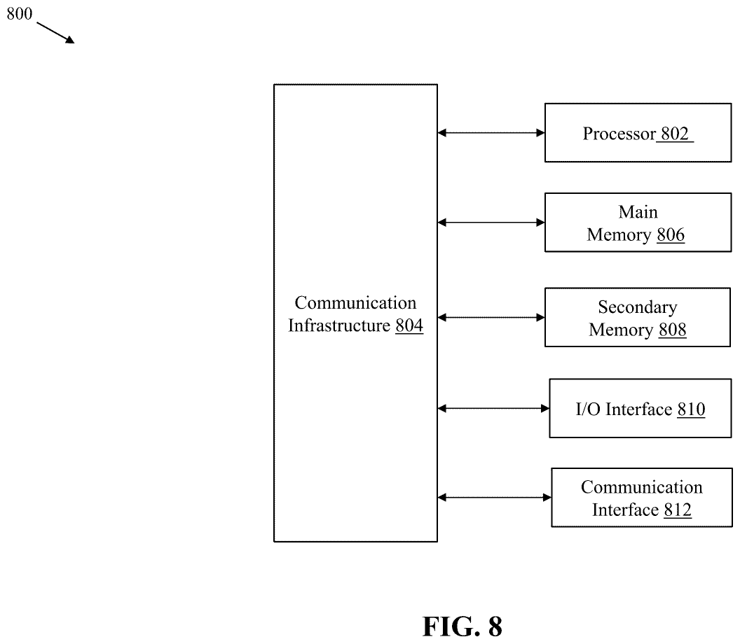

FIG. 8 is a block diagram that illustrates a system architecture of a computer system 800 of the system environment 100 of FIG. 1, in accordance with an exemplary embodiment of the present disclosure. An embodiment of disclosure, or portions thereof, may be implemented as computer-readable code on the computer system 800. In one example, each of the plurality of user devices 106, each of the plurality of merchant terminals 110, the payment network server 112, the issuer server 114, and the acquirer server 116 may be implemented as the computer system 800. Hardware, software, or any combination thereof may embody modules and components used to implement the methods of FIG. 5, FIG. 6, and FIGS. 7A-7C. The computer system 800 may include a processor 802, a communication infrastructure 804, a main memory 806, a secondary memory 808, an input/output (I/O) interface 810, and a communication interface 812.

The processor 802 may be a special-purpose or a general-purpose processing device. The processor 802 may be a single processor, multiple processors, or combinations thereof. Further, the processor 802 may be connected to the communication infrastructure 804, such as a bus, message queue, multi-core message-passing scheme, and the like.

The main memory 806 may be configured to store instructions that facilitate various operations described in conjunction with FIG. 5, FIG. 6, and FIGS. 7A-7C. Examples of the main memory 806 may include a RAM, a ROM, and the like. The secondary memory 808 may include a hard disk drive (HDD) or a removable storage drive, such as a floppy disk drive, a magnetic tape drive, a compact disc, an optical disk drive, a flash memory, and the like. In an embodiment, the removable storage drive may be a non-transitory computer-readable medium.

The I/O interface 810 includes various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may correspond to signals, such as electronic, electromagnetic, optical, or other signals as will be apparent to a person skilled in the art.

Embodiments in the present disclosure provide the system environment 100 and the method for facilitating fraud detection based on collaborative filtering. The payment network server 112 leverages the first historical transaction data 210 and the second historical transaction data 214 associated with the plurality of payment modes 104 and the plurality of merchants 108 to detect fraudulent transaction requests. Segregation of the plurality of payment modes 104 into the plurality of payment mode clusters 306 and the plurality of merchants 108 into the plurality of merchant clusters 308 enables the capturing of broader patterns and improved scalability for large datasets. Additionally, cluster-level patterns (e.g., the CF matrix 216) are used to determine the CF score, even for previously unseen payment mode-merchant pairs. In other words, the behavior of similar entities is utilized for fraud detection results in improved accuracy during fraud detection. Additionally, fraud detection by the payment network server 112 reduces the processing load on the issuer server 114 as the issuer server 114 relies on the payment network server 112 for fraud detection. The fraud detection technique described in one or more embodiments of the present disclosure provides higher accuracy in fraud detection as compared with conventional fraud detection techniques. The higher accuracy occurs due to the utilization of historical transactions associated with similar merchants and similar payment modes. Additionally, the time and computational power required for training the risk score ML model is significantly lower in comparison to the conventional fraud detection techniques.

Techniques consistent with the present disclosure provide, among other features, systems and methods for facilitating fraud detection based on collaborative filtering. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

Techniques consistent with the present disclosure provide, among other features, methods for facilitating fraud detection based on collaborative filtering. In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A method, comprising:
segregating, by a server, (i) a plurality of payment modes into a plurality of payment mode clusters and (ii) a plurality of merchants into a plurality of merchant clusters, based on first historical transaction data;
generating, by the server, a collaborative filtering (CF) matrix based on the plurality of payment mode clusters, the plurality of merchant clusters, and second historical transaction data, wherein each cell of the CF matrix is associated with a corresponding payment mode cluster of the plurality of payment mode clusters and a corresponding merchant cluster of the plurality of merchant clusters;
determining, by the server, a CF score for each cell of the CF matrix;
creating, by the server, a plurality of CF feature values for each cell of the CF matrix based on a corresponding CF score and the second historical transaction data; and
training, by the server, a risk score machine-learning (ML) model based on the created plurality of CF feature values and a plurality of non-CF feature values, wherein the risk score ML model is operable to classify a transaction request as one of a fraudulent transaction request or a legitimate transaction request based on the training.

2. The method of claim 1, wherein the segregation of the plurality of payment modes into the plurality of payment mode clusters and the plurality of merchants into the plurality of merchant clusters, comprises:
creating, by the server, a plurality of payment mode clustering features for each payment mode of the plurality of payment modes and a plurality of merchant clustering features for each merchant of the plurality of merchants based on the first historical transaction data; and
executing, by the server, a trained clustering ML model, based on the created plurality of payment mode clustering features and the created plurality of merchant clustering features.

3. The method of claim 2, further comprising training, by the server, a clustering ML model to obtain the trained clustering ML model.

4. The method of claim 1, further comprising storing, by the server, the plurality of CF feature values associated with each cell of the CF matrix in a memory.

5. The method of claim 1, wherein each payment mode cluster of the plurality of payment mode clusters includes a set of similar payment modes of the plurality of payment modes and each merchant cluster of the plurality of merchant clusters includes a set of similar merchants of the plurality of merchants.

6. The method of claim 1, wherein each cell of the CF matrix is indicative of a number of transactions between the corresponding payment mode cluster of the plurality of payment mode clusters and the corresponding merchant cluster of the plurality of merchant clusters.

7. The method of claim 6, wherein the CF score of each cell corresponds to a ratio of a corresponding number of transactions between the corresponding payment mode cluster and the corresponding merchant cluster to a sum of a number of transactions of the corresponding payment mode cluster with each of the plurality of merchant clusters.

8. The method of claim 1, wherein the plurality of payment modes and the plurality of merchants are associated with a geographical location.

9. The method of claim 1, wherein the first historical transaction data and the second historical transaction data are mutually exclusive.

10. The method of claim 1, wherein the first historical transaction data and the second historical transaction data are mutually inclusive.

11. The method of claim 1, wherein the first historical transaction data and the second historical transaction data are identical.

12. The method of claim 1, wherein each merchant cluster of the plurality of merchant clusters is associated with a merchant transaction pattern, and wherein each payment mode cluster of the plurality of payment mode clusters is associated with a payment mode transaction pattern.

13. The method of claim 1, wherein each payment mode of the plurality of payment modes corresponds to one of a payment card, a digital wallet, or a virtual payment address.

14. A method, comprising:
receiving, by a server, a transaction request associated with a target payment mode and a target merchant;
identifying, by the server, a target payment mode cluster of a plurality of payment mode clusters that is associated with the target payment mode and a target merchant cluster of a plurality of merchant clusters that is associated with the target merchant;
retrieving, by the server from a memory, a plurality of collaborative filtering (CF) feature values associated with the target payment mode cluster and the target merchant cluster;
inputting, by the server, the retrieved plurality of CF feature values and a plurality of non-CF feature values associated with at least one of the target payment mode and the target merchant, to a trained risk score machine-learning (ML) model; and
obtaining, by the server, a risk score as an output of the trained risk score ML model, wherein the transaction request is classified as one of a fraudulent transaction request or a legitimate transaction request based on the risk score.

15. The method of claim 14, further comprising:
determining, by the server, the transaction request as the fraudulent transaction request based on the risk score; and
transmitting, by the server, an alert message to an issuer associated with the target payment mode, wherein the alert message indicates the issuer to reject the transaction request.

16. The method of claim 14, further comprising:
receiving, by the server, an indication that the transaction request is one of the fraudulent transaction request or the legitimate transaction request after the classification of the transaction request as one of the fraudulent transaction request or the legitimate transaction request;
generating, by the server, a plurality of weights associated with the trained risk score ML model based on the indication; and
retraining, by the server, the trained risk score ML model based on the generated plurality of weights.

17. The method of claim 14, wherein the transaction request is associated with one of a card present transaction, a card not present transaction, an electronic wallet (e-wallet) payment transaction, or a mobile payment transaction.

18. The method of claim 14, wherein the target payment mode cluster is identified based on a similarity in a payment mode transaction pattern of the target payment mode and a payment mode transaction pattern of the target payment mode cluster.

19. The method of claim 14, wherein the target merchant cluster is identified based on a similarity in a merchant transaction pattern of the target merchant and a merchant transaction pattern of the target merchant cluster.

20. A system, comprising:
a memory configured to store a risk score machine-learning (ML) model;
processing circuitry coupled to the memory and configured to:
segregate a plurality of payment modes into a plurality of payment mode clusters and a plurality of merchants into a plurality of merchant clusters, based on first historical transaction data;
generate a collaborative filtering (CF) matrix based on the plurality of payment mode clusters, the plurality of merchant clusters, and second historical transaction data, wherein each cell of the CF matrix is associated with a corresponding payment mode cluster of the plurality of payment mode clusters and a corresponding merchant cluster of the plurality of merchant clusters;
determine a CF score for each cell of the CF matrix;
create a plurality of CF feature values for each cell of the CF matrix based on the corresponding CF score and the second historical transaction data; and
train the risk score ML model based on the created plurality of CF feature values and a plurality of non-CF feature values, wherein the risk score ML model is operable to classify a transaction request as one of a fraudulent transaction request or a legitimate transaction request based on the training.
